(19) United States
(12) Patent Application Publication
(10) Pub. No.: US 2025/0269555 A1
(43) Pub. Date: Aug. 28, 2025

(54) HIGH-DENSITY HEAT STORAGE MOLDED BODY HAVING POROUS STRUCTURE STABLE IN HEAT STORAGE AND RELEASE CYCLE, AND METHOD FOR MANUFACTURING SAME

(71) Applicant: KOREA INSTITUTE OF ENERGY RESEARCH, Daejeon (KR)

(72) Inventors: Sung-kook HONG, Cheongju-si (KR); Si-won YOON, Sejong (KR); Tae-woo KIM, Daejeon (KR); Jong Hoon JOO, Gwangju (KR); Soomin CHOI, Cheongju-si (KR); Gyeong Duk NAM, Gwangju (KR)

(73) Assignee: KOREA INSTITUTE OF ENERGY RESEARCH, Daejeon (KR)

(21) Appl. No.: 18/700,915

(22) PCT Filed: Jun. 27, 2023
(86) PCT No.: PCT/KR2023/008883

§ 371 Date: Sep. 17, 2024

(30) Foreign Application Priority Data
Jul. 7, 2022 (KR) 10-2022-0083971

(51) Int. Cl. B28B 1/50; B28B 1/52; B28B 11/24

(52) U.S. Cl. CPC B28B 1/50; B28B 1/52; B28B 11/243

(57) ABSTRACT

The present disclosure relates to a method for manufacturing a high-density heat storage molded body having a porous structure stable in a heat storage and release cycle, more particularly, to a method for manufacturing a molded body that is stable in a heat storage and release cycle, which includes steps of: preparing ceramic powder; mixing ceramic fibers with the ceramic powder; pressing and molding a mixed powder; and manufacturing the manufactured molded body in the form of a porous molded body by high-temperature heat treatment.

### TECHNICAL FIELD

The present disclosure relates to a high-density heat storage molded body having a porous structure in the heat storage and release cycle, and a method for manufacturing the same.

### RELATED ART

According to the U.S. Department of energy, the amount of waste heat generated from industry is approximately 7,400 PJ/y, which exceeds the total amount of energy produced from all renewable energy sources. Additionally, waste heat in the field of industry, which consumes the largest portion of the country's total energy, accounts for 8% of the total energy. Despite this enormous potential, it is still largely underutilized. The main reason for this is the lack of technology to store and utilize industrial waste heat. To address this, high-density heat storage technologies are urgently needed to overcome the low storage density limitations of current heat storage technologies.

Heat storage technologies can be categorized into sensible heat storage, latent heat storage, and thermochemical heat storage. Among these, the thermochemical heat storage is garnering attention as a next-generation heat storage technology due to its remarkably high energy density, lower heat loss, and longer storage duration. The thermochemical heat storage is a technology that stores and uses heat for a long period of time using the endothermic-exothermic reaction that occurs as a material such as calcium carbonate, zeolite or the like is chemically converted.

As a thermochemical heat storage material for storing low-to-medium temperature (150-300° C.) waste heat, the heat storage density of magnesium oxide (MgO) is 3.4 GJ/m³, which is 17 times higher than that of water that is a general heat storage material, and is approximately 4.3 times higher than the heat storage density of Zeolite being widely studied in the thermochemical heat storage technology. Additionally, MgO is considered the most promising high-density storage material in terms of storage density and stability due to its nontoxic nature and low cost.

To date, numerous studies have been explored on MgO as a heat storage material, focusing on kinetics improvement studies through doping in the form of powder, and material development such as studies on heat storage temperature drop through additives.

However, in the case of power form, a decrease in the reaction surface area is caused by powder agglomeration phenomenon occurring during the heat storage and release cycle, leading to a decrease in heat storage performance. In order to address this issue, a technology for manufacturing heat storage materials in a form of a molded body is required. However, the shape retention of the molded body is challenging during the heat storage and release cycle due to the volume change associated with the phase change of MgO-based materials. Therefore, research on this topic is still in its early stage.

### SUMMARY

### Technical Problem

Therefore, the present disclosure is contrived to solve conventional problems as described above. According to an embodiment of the present disclosure, it aims to develop a molding technology of high-density heat storage material (MgO) based on ceramic sintering technology and to provide a technology for manufacturing a multi-structured material capable of maintain heat storage and release cycle characteristics of MgO material.

According to an embodiment of the present disclosure, it aims to provide a technology for manufacturing a porous heat storage molded body with stability in the heat storage and release cycle by synthesizing MgO that is a high-density heat storage material through a wet powder preparation process, and then adding SiC fibers.

Meanwhile, technical objects to be achieved in the present invention are not limited to the aforementioned technical objects, and other technical objects, which are not mentioned above, will be apparently understood to a person having ordinary skill in the art from the following description.

### Technical Solution

A first aspect of the present disclosure relates to a molded body that is stable in a heat storage and release cycle by adding ceramic fibers, and may be achieved as a thermochemical heat storage molded body including: ceramic powder; and ceramic fibers mixed with the ceramic powder.

The ceramic powder mixed with ceramic fibers is subjected to pressure molding and high-temperature heat treatment to form a porous molded body shape.

In addition, the ceramic fiber is at least one of an SiC fiber, an Al₂O₃ fiber and a ZrO₂ fiber, and the ceramic powder is at least one of a powder of a char state including an organic compound, a MgO powder, and a CaO powder.

A second aspect of the present disclosure relates to a method for manufacturing a molded body that is stable in a heat storage and release cycle by adding ceramic fibers, and may be achieved as a method for manufacturing a thermochemical heat storage molded body including steps of: preparing ceramic powder; mixing ceramic fibers with the ceramic powder; pressing and molding a mixed powder; and manufacturing the manufactured molded body in the form of a porous molded body by high-temperature heat treatment.

In the step of preparing the ceramic power, a ceramic powder synthesized by a wet process or a commercially available powder is prepared.

Further, the wet process is at least one of a Pechini method, a sol-gel method and a Colloidal process.

In the step of mixing ceramic fibers with the ceramic powder, in the case of the commercially available powder, a pore-forming agent is added to form a porous structure.

Further, the ceramic fiber is at least one of an SiC fiber, an Al₂O₃ fiber and a ZrO₂ fiber. In the step of mixing ceramic fibers with the ceramic powder, in the case of the powder synthesized by a wet process, the powder in a char state including an organic compound is mixed with the ceramic fibers.

In the step of mixing ceramic fibers with the ceramic powder, a mass ratio of the added ceramic fibers is in a range of 0.5˜5% with respect to the char powder.

Further, in the step of pressing and molding a mixed powder, the mixed powder is placed into a mold to be pressed and molded. The surface area of the molded body is determined by the surface area of the mold, and the thickness thereof is determined according to the amount of the powder.

The ceramic powder is at least one of a MgO powder and a CaO powder. For MgO powder preparation via the Pechini method, magnesium nitrate is dissolved in distilled water, citric acid is added to facilitate synthesis of a solution to which nitrate is added, and ammonium hydroxide is used to adjust the pH to a proper level.

Further, in the step of manufacturing a porous molded body by heat treating the manufactured molded body at high temperatures, organic residues included in char are removed to form pores during the heat treatment.

The manufactured porous molded body has a porosity of 30˜70%.

Further, the step of heat treating the manufactured molded body at high temperature is performed in air at 800° C. to 1300° C. for 2 to 5 hours.

### Advantageous Effects

According to a method for manufacturing a high-density heat storage molded body having a porous structure stable in a heat storage and release cycle in accordance of an embodiment of the present disclosure, it is capable of developing a molding technology of high-density heat storage material (MgO) based on ceramic sintering technology and providing a technology for manufacturing a multi-structured material capable of maintain heat storage and release cycle characteristics of MgO material.

According to a method for manufacturing a high-density heat storage molded body having a porous structure stable in a heat storage and release cycle in accordance of an embodiment of the present disclosure, it is capable of manufacturing a porous heat storage molded body with stability in the heat storage and release cycle by synthesizing MgO that is a high-density heat storage material through a wet powder preparation process, and then adding SiC fibers.

Conventional studies on thermochemical heat storage technology of MgO have been developed mainly on the basis of a powder form. However, in order for actual adoption of a THS (Thermochemical Heat Storage) system, a manufacturing technology in the form of a molded body is required. In the case of MgO, the unstable structural integrity of the molded body due to volume expansion and contraction during the heat storage and release cycle causes powderization and agglomeration of the molded body, which leads to a decrease in material diffusion and a degradation of cycle characteristics. This is a factor that hinders the adoption of the THS system to MgO. According to a method for manufacturing a high-density heat storage molded body having a porous structure stable in a heat storage and release cycle in accordance with an embodiment of the present disclosure, limitations of conventional heat storage technology of MgO-based materials are overcome due to the high mechanical stability and stable performance during repeated heat storage and release cycles. Additionally, the manufacturing process is highly simplified, and the molded body is easily manufactured without restrictions on the shape and size thereof, making the same highly advantageous from both commercial and practical perspectives. This high-density, reliable heat storage technology can serve as a bridge between materials and actual systems, and can greatly contribute to the adoption of a proven THS system to developed heat storage materials.

Meanwhile, advantageous effects to be obtained in the present disclosure are not limited to the aforementioned effects, and other effects, which are not mentioned above, will be apparently understood to a person having ordinary skill in the art from the following description.

### BRIEF DESCRIPTION OF THE DRAWINGS

The accompanying drawings of this specification exemplify a preferred embodiment of the present disclosure, the spirit of the present disclosure will be more clearly understood from the following detailed description taken in conjunction with the accompanying drawings, and thus it will be understood that the present disclosure is not limited to only contents illustrated in the accompanying drawings;

FIG. 1 shows a flowchart of a method for manufacturing a high-density heat storage molded body having a porous structure stable in a heat storage and release cycle according to an embodiment of the present disclosure,

FIG. 2 shows images of thermochemical heat storage molded bodies manufactured according to embodiments of the present disclosure, a) molded body without SiC fibers and b) molded body with SiC fibers,

FIG. 3 shows a table showing porosity, hydration conversion rate, and dehydration conversion rate of thermochemical heat storage molded bodies manufactured according to an embodiment of the present disclosure,

FIG. 4 shows XRD graphs of molded bodies with SiC fibers manufactured according to the present disclosure, a) before hydration and b) after hydration,

FIG. 5 shows SEM images of a molded body with SiC fibers manufactured according to an embodiment of the present disclosure,

FIG. 6 shows heat storage and release cycle stability test of a molded body with SiC fibers manufactured according to an embodiment of the present disclosure, and

FIG. 7 shows images after heat storage and release cycles of molded bodies manufactured according to an embodiment of the present disclosure, a) molded body without SiC fibers and b) a molded body with SiC fibers.

### DETAILED DESCRIPTION

### Best Mode

Hereinafter, a method for manufacturing a high-density heat storage molded body having a porous structure stable in a heat storage and release cycle according to an embodiment of the present disclosure will be described. According to an embodiment of the present disclosure, a molding technology of a high-density heat storage material (MgO) is developed based on ceramic sintering technology, and a technology for manufacturing a multi-structured material capable of maintain heat storage and release cycle characteristics of MgO material is provided.

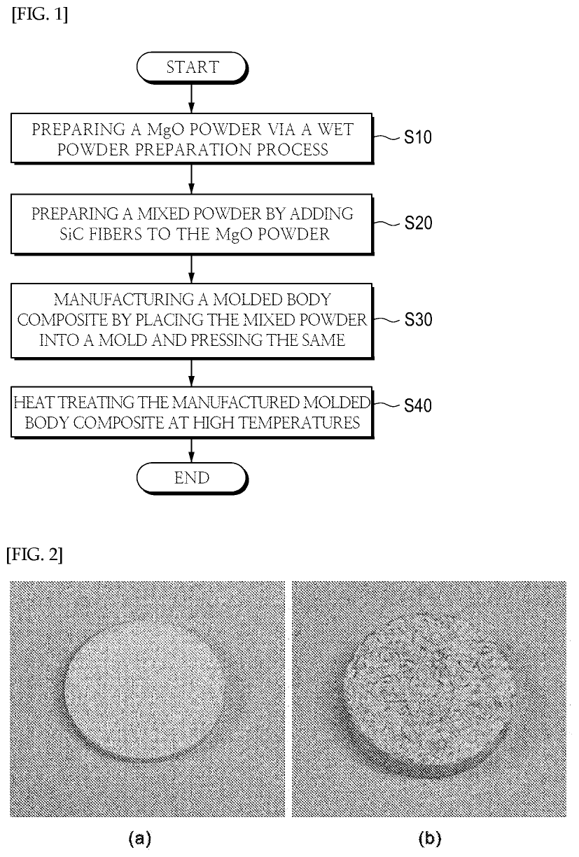

FIG. 1 shows a flowchart of a method for manufacturing a high-density heat storage molded body having a porous structure stable in a heat storage and release cycle according to an embodiment of the present disclosure.

Firstly, ceramic powder is prepared (S10). In an embodiment of the present disclosure, the ceramic powder may be composed of a MgO powder, a CaO powder and the like, and may be use a commercially available powder or a ceramic powder prepared by a wet powder preparation process.

In the case of the commercially available powder, in order to form a porous structure, a pore-forming agent such as carbon black, starch, graphite, rice husk and the like is added.

To ensure smooth water vapor supply and to buffer the stress caused by volume changes occurring during a heat storage and release cycle, it is necessary to develop a porous molded body. Firstly, to manufacture a porous molded body, nano-powder materials synthesized based on wet powder preparation processes (Such as a Pechini method, a sol-gel method and a Colloidal process) are utilized. For example, in the Pechini method, magnesium nitrate (magnesium nitrate hexahydrate (Mg(NO₃)₂·6H₂O) is dissolved in distilled water synthesize powder using a wet preparation process. At this time, citric acid is added to facilitate synthesis of a solution to which nitrate is added, and ammonium hydroxide is used to adjust the pH to a proper level. The powder synthesized by this wet powder preparation method includes organic residues. In other words, the powder synthesized by the wet powder preparation method has a powder form in a char state includes organic residues.

In an embodiment of the present disclosure, a ceramic fiber (hereinafter, referred to as fiber) is added to a MgO powder to prepare a mixed powder (S20). The ceramic fiber may be an SiC fiber, an Al₂O₃ fiber and a ZrO₂ fiber.

When mixing the ceramic powder with SiC fibers, a mass ratio of the added SiC fibers is suggested to be in a range of 0.5˜5% with respect to the char powder, and the char powder and SiC fibers are mixed uniformly.

In other words, in an embodiment of the present disclosure, in order to overcome the decrease in heat storage characteristics caused by volume expansion during the heat storage and release cycle, a MgO composite is manufactured by adding ceramic SiC fibers. The addition of a small amount of SiC fibers suppresses not only the occurrence of cracks caused by volume expansion during hydration of MgO, by the bonding between the fibers and a matrix (MgO), but also the progress of cracks by bridging (bridging action) with the matrix.

Nano-ceramic powder synthesized using a wet preparation method and SiC fibers are mixed to prepare a mixed powder. The mixed powder is placed into a mold with desired shape and size and pressed to form a molded body (S30). There are no restrictions on the shape of the mold, and the surficial area of the molded body is determined by the surface area of the mold. The thickness thereof is determined according to the amount of the mixed powder, and there are no restrictions on the thickness.

Finally heat treatment is performed to remove organic residues, resulting in the manufacture of a porous MgO—SiC fiber composite with SiC fibers added. Organic residues included in char are removed to form pores. The manufactured porous molded body has a porosity of 30˜70%. The step of heat treating the manufactured molded body at high temperatures is performed in air at 800° C. to 1300° C. for 2 to 5 hours.

### Description of Embodiments

Hereinafter, experimental results of the thermochemical heat storage molded body manufactured according to the aforementioned embodiments of the present disclosure will be described.

FIG. 2 shows images of thermochemical heat storage molded bodies manufactured according to embodiments of the present disclosure, a) molded body without SiC fibers and b) molded body with SiC fibers.

Both molded bodies underwent heat treatment at 1100° C. for 3 hours. Heat storage molded bodies in various shape and size can be manufactured by selecting a mold that matches the desired shape and size.

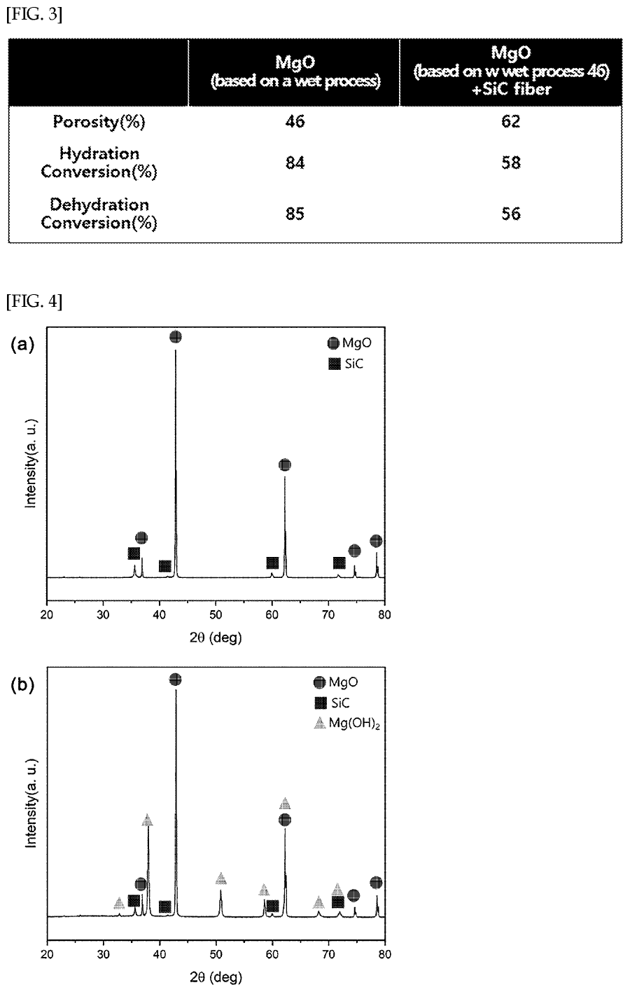

FIG. 3 shows a table showing porosity, hydration conversion rate, and dehydration conversion rate of thermochemical heat storage molded bodies manufactured according to an embodiment of the present disclosure. The porosity was measured using the Archimedes method, and a higher porosity was confirmed in the SiC-added molded body.

FIG. 4 shows XRD graphs of molded bodies with SiC fibers manufactured according to the present disclosure, a) before hydration and b) after hydration. As shown in FIG. 4, both MgO and SiC peaks were observed before hydration. Additionally, after hydration, a MgO peak was also observed along with Mg(OH)₂ and SiC peaks, which were formed during the hydration. This was because the hydration was not 100%.

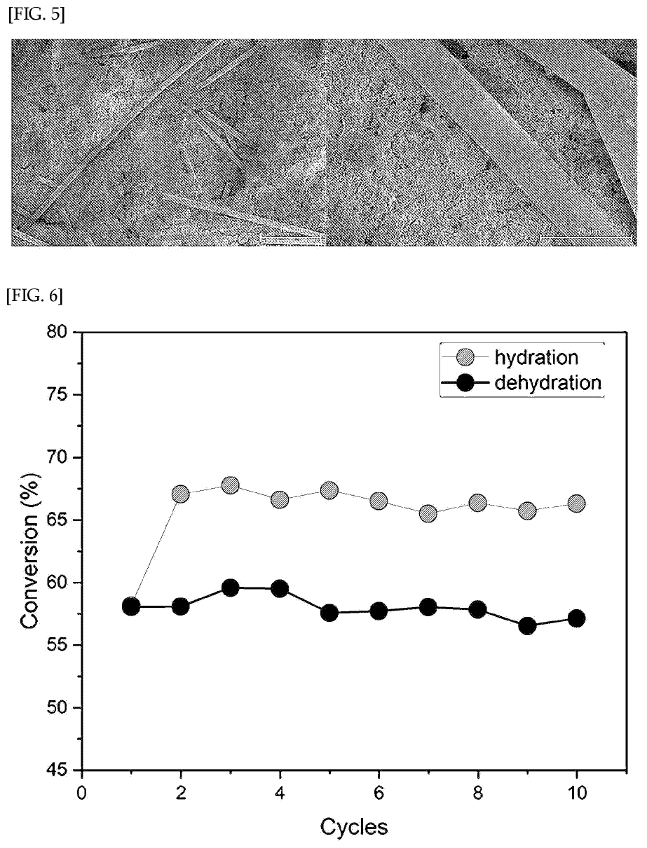

FIG. 5 shows SEM images of a molded body with SiC fibers manufactured according to an embodiment of the present disclosure. As shown in FIG. 5, it was confirmed that the manufactured molded body has a porous structure. Also, it was confirmed that the added SiC fibers were well-bonded to the MgO matrix and act as a bridge.

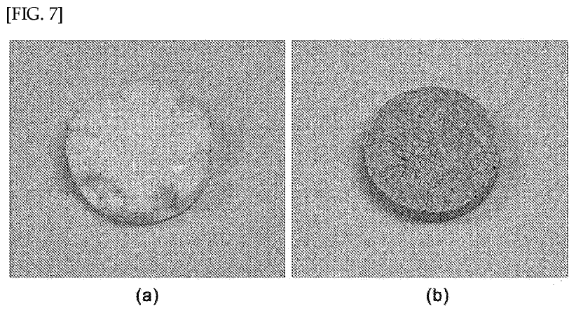

FIG. 6 shows heat storage and release cycle stability test of a molded body with SiC fibers manufactured according to an embodiment of the present disclosure. In other words, FIG. 6 shows the hydration and dehydration rates in the heat storage and release cycle stability test of the SiC fiber-added molded body. As shown in FIG. 6, it is seen that the molded body exhibited stable hydration (˜65%) and dehydration (˜57%) conversion rates without performance degradation after 10 heat storage and release cycles.

FIG. 7 shows images after heat storage and release cycles of molded bodies manufactured according to an embodiment of the present disclosure, a) molded body without SiC fibers and b) a molded body with SiC fibers.

a) in FIG. 7 is the image of a molded body without SiC fibers after the first cycle. Cracks were observed in the molded body due to the volume change caused by the phase change to Mg(OH)₂ due to hydration, which made it impossible to maintain the shape of the molded body. On the other hand, b) is the image of a molded body with SiC fibers after 10^{th} cycles. The shape retention was confirmed even after repeated heat storage and release cycles.

Furthermore, the apparatus and methods described above are not intended to be limited to the configurations and methods of the embodiments described above, but may be configured with optional combinations of all or portions of each embodiment so that various variations may be made.

1. As a molded body that is stable in a heat storage and release cycle by adding ceramic fibers, a thermochemical heat storage molded body comprising:
ceramic powder; and
ceramic fibers mixed with the ceramic powder.

2. The thermochemical heat storage molded body of claim 1, wherein
the ceramic powder mixed with ceramic fibers is subjected to pressure molding and high-temperature heat treatment to form a porous molded body shape.

3. The thermochemical heat storage molded body of claim 2, wherein
the ceramic fiber is at least one of an SiC fiber, an Al₂O₃ fiber and a ZrO₂ fiber, and
the ceramic powder is at least one of a powder of a char state including an organic compound, a MgO powder, and a CaO powder.

4. As a method for manufacturing a molded body that is stable in a heat storage and release cycle by adding ceramic fibers, a method for manufacturing a thermochemical heat storage molded body comprising steps of:
preparing ceramic powder;
mixing ceramic fibers with the ceramic powder;
pressing and molding a mixed powder; and
manufacturing the manufactured molded body in the form of a porous molded body by high-temperature heat treatment.

5. The method for manufacturing a thermochemical heat storage molded body of claim 4, wherein
in the step of preparing the ceramic power,
a ceramic powder synthesized by a wet process or a commercially available powder is prepared.

6. The method for manufacturing a thermochemical heat storage molded body of claim 5, wherein
the wet process is at least one of a Pechini method, a sol-gel method and a Colloidal process.

7. The method for manufacturing a thermochemical heat storage molded body of claim 5, wherein
in the step of mixing ceramic fibers with the ceramic powder, in the case of the commercially available powder, a pore-forming agent is added to form a porous structure.

8. The method for manufacturing a thermochemical heat storage molded body of claim 5, wherein
the ceramic fiber is at least one of an SiC fiber, an Al₂O₃ fiber and a ZrO₂ fiber, and
in the step of mixing ceramic fibers with the ceramic powder, in the case of the powder synthesized by a wet process, the powder in a char state including an organic compound is mixed with the ceramic fibers.

9. The method for manufacturing a thermochemical heat storage molded body of claim 8, wherein
in the step of mixing ceramic fibers with the ceramic powder, a mass ratio of the added ceramic fibers is in a range of 0.5˜5% with respect to the char powder.

10. The method for manufacturing a thermochemical heat storage molded body of claim 4, wherein
in the step of pressing and molding a mixed powder, the mixed powder is placed into a mold to be pressed and molded, and
the surface area of the molded body is determined by the surface area of the mold, and the thickness thereof is determined according to the amount of the powder.

11. The method for manufacturing a thermochemical heat storage molded body of claim 6, wherein
the ceramic powder is at least one of a MgO powder and a CaO powder, and
for MgO powder preparation via the Pechini method, magnesium nitrate is dissolved in distilled water, citric acid is added to facilitate synthesis of a solution to which nitrate is added, and ammonium hydroxide is used to adjust the pH to a proper level.

12. The method for manufacturing a thermochemical heat storage molded body of claim 8, wherein
in the step of manufacturing a porous molded body by heat treating the manufactured molded body at high temperatures, organic residues included in char are removed to form pores during the heat treatment.

13. The method for manufacturing a thermochemical heat storage molded body of claim 12, wherein
the manufactured porous molded body has a porosity of 30˜70%.

14. The method for manufacturing a thermochemical heat storage molded body of claim 4, wherein
the step of heat treating the manufactured molded body, the manufactured molded body at high temperatures is performed in air at 800° C. to 1300° C. for 2 to 5 hours.
